(19) United States
(12) Patent Application Publication
(10) Pub. No.: US 2002/0154298 A1
(43) Pub. Date: Oct. 24, 2002

(54) Method of inspecting an edge of a glass disk for anomalies in an edge surface

(75) Inventors: John Patrick Hagen, Rochester, MN (US); Daniel A. Neseth, Mantorville, MN (US)

Correspondence Address: James R. Nock, IBM Corporation, Dept. 917, 3605 Highway 52 North, Rochester, MN, 55901-7829, US

(73) Assignee: INTERNATIONAL BUSINESS MACHINES CORPORATION, ARMONK, NY

(21) Appl. No.: 09/841,527

(22) Filed: Apr. 24, 2001

(51) Int. Cl. G01N 21/88

(52) U.S. Cl. 356/239.1

(57) ABSTRACT

A glass disk is illuminated through an edge and an image of a segment of the disk edge is captured by a CCD camera. If internally reflected light is refracted and diffused by an anomaly in a disk edge, the anomaly will appear as a brilliant light spot on the image. Brilliant spots on a disk edge are detected as bright pixels; and within inspection zones, rows of pixels or areas of pixels are compared with a threshold value. Pixel strings having illumination intensity greater than the threshold are counted; and whenever the resulting count is larger than a predetermined number, the disk is rejected as having an anomaly of a size warranting rejection. In inspection area zones, pixel counts of intensities greater than a threshold value warrant rejection.

### CROSS-REFERENCE TO RELATED CO-PENDING UNITED STATES PATENT APPLICATION

The following U.S. patent application is related to this invention and is incorporated herein in its entirety: DEVICE AND METHOD FOR INSPECTING A DISK FOR PHYSICAL DEFECTS, Ser. No. 09/489,342, filed Jan. 21, 2000, by John P. Hagen and Daniel A. Neseth, said application commonly assigned herewith.

### FIELD OF THE INVENTION

This invention relates to the inspection of glass disk substrates for high-speed data storage disks and, more particularly, to a method for detecting anomalies such as cracks and chips in an edge surface of such disks and then rejecting any disks either having anomalies of a predetermined size or anomalies occurring in large enough numbers within a predetermined area, but without regard to size.

### BACKGROUND OF THE INVENTION

Magnetic data storage disks have been made using a number of different materials for substrates. Some of the substrates have been made of rigid plastics, flexible plastics and aluminum or alloys thereof. The flexible disks are known as floppy disks and typically are very inexpensive as compared to hard or rigid disks which are used in hard drives to receive and store significantly more data than on floppy disks. Hard disks are precision manufactured to a very high criteria to accommodate very large amounts of data and high density data storage as well as to operate at very high rates of rotational speed, in the order of 15,000 revolutions per minute (rpms). The very high rate of rotational speed at which the disk operates creates very large centrifugal forces which can severely stress the substrate materials.

When exerted on an aluminum or other metal disk, stresses generally are not a significant factor in failures of the metal disk substrate. However, with the requirement for faster and higher density recording of and faster access to the data along with continued emphasis to improve data access times, rotational speeds have been increased drastically to accomplish reduction in data access times.

Because the read/write transducers used in the hard disk drives are supported or flown above the recoding surfaces on an air-bearing layer and fly over the surface of the rotating disk at a very small attitude, the time required for a read/write transducer to react to a slight surface irregularity has been greatly reduced even with an increase in rotational speed of the disks. With this reduction in reaction time, the surface quality or smoothness of the magnetic recording coating on the surface of the disk substrate becomes critical; therefore, surface quality must be improved to prevent transducer crashes into the recording surface of a disk.

Glass allows the formation of very smooth surfaces, especially with polishing. However, being only about 1 mm thick, the glass disk substrates are very fragile and subject to breakage. Due to centrifugal forces stressing pre-existing chips or cracks in the edge of the disk, the chips or cracks may cause the glass disk substrate to shatter during rotation.

Accordingly, edge anomalies are one source of disastrous failure. Whenever a glass disk breaks in a disk drive, not only is the drive is disabled and must be replaced; more importantly, the data recorded thereon is lost and must be reconstituted on another disk in another disk drive. This occurrence is extremely expensive and disruptive. The breakage typically is the result of the glass disk having an anomaly in its structure which causes stress concentrations, thereby weakening the structure of the substrate. Typical anomalies may include chips and cracks which affect the integrity of the glass disk. Not only must any anomalies in the disk and on the planar surfaces of the disk be detected, but also an edge of the disk is such a significant structural portions of the disk that the weakness of the edge from a chip or crack may lead to the disk shattering. Centrifugal forces created by very high rotational speeds of operation, as in high-speed disk drives, can destroy a glass disk because of the weakness caused by an edge chip or crack.

Techniques have been developed to inspect glass disk substrates for and detect the presence of major cracks and surface imperfections on surfaces to be coated as the recording surfaces of a magnetic disk. However, the inspection technique for this type of inspection does not address the need to inspect a cylindrical edge surface of a disk lying between the chamfers which connect the recording surfaces and the peripheral cylindrical surface or edge surface of the glass disk substrate. The above identified cross-referenced co-pending United States Patent Application discloses this inspection technique.

### OBJECTS OF THE INVENTION

It is an object of the invention to provide a method of inspecting glass disk edges for cracks and chips.

It is another object of the invention to detect the existence of anomalies in the glass material constituting the edge of a glass disk.

It is a further object of the invention to detect and determine at least one relative dimension of defects in an edge of a glass disk.

It is still another object of the invention to eliminate magnetic data storage disk glass substrates with certain defects in an edge of the glass disk before the manufacturing process is complete.

It is still a further object of the invention to delineate the size of anomalies in an edge material of a magnetic data storage disk glass substrate and to indicate the unacceptable status of a substrate based upon size of the anomaly.

Additional Objects of the Invention will become apparent to those skilled in the art with a more complete understanding of the invention. The foregoing objects of the invention are not intended to nor should they be used in any manner to limit the scope of the invention as set forth below in the appended claims.

### SUMMARY OF THE INVENTION

An electro-optical system is employed to rapidly and efficiently detect any cracks and chips which are too small to be detected visually in an edge of glass disk substrates, but which may sufficiently weaken the glass disk to endanger its physical integrity during periods of very high-speed rotation.

The electro-optical system comprises at least one high-intensity light source which incorporates a focusing or light directing device, such as a lens, or preferably an optical fiber or optical fiber bundle precisely directing the illumination onto an edge of a disk, while the disk is slowly rotated to present sequential portions of a disk edge at an inspection station, which is fixed with respect to the light source. The light beam emanating from the light source is oriented or directed such that light rays may not pass directly to an optical sensor positioned to view individual small segments of a peripheral edge of the glass disk at the inspection station location.

The optical sensor is a high-speed digital recording camera which detects various illumination levels of very small areas on an edge of the glass disk within the field of view of the sensor.

As light from one or more such high intensity light sources is passed through a cylindrical edge surface and into the body of the glass disk, the light rays are continually reflected from the interior of a cylindrical edge surface within the disk. This internal reflection continues until a light ray strikes the interior of an edge surface of the disk at such an angle to permit the light ray to pass through the surface of the glass into the surrounding air rather than be internally reflected, blocked or intercepted by and impinged onto an anomaly in the glass. Assuming that the disk has been previously inspected by other inspection processes for anomalies in the main body of the disk, as described in the above identified and related patent application, the anomalies detected by this invention are primarily located at the edge of the disks.

As the reflecting light rays strike an anomaly, such as a crack or chip, in an edge surface of the disk, the light ray is diffused; and, cumulatively, the diffused light rays illuminate the anomaly and present the anomaly at a significantly brighter level than the illumination level of the surrounding non-defective, internally reflective surface material of an edge of the disk.

The optical sensor employed is preferably a charge-coupled device (CCD optical camera or CCD sensor) which contemporaneously captures the image of a segment of a disk edge as the disk is rotated past the sensor and electronically records the illumination levels of the small spots making up the surface of an edge of the disk as pixels (picture elements) in the sensor. Data representing the characteristics of those pixels in the memory of the sensor device are thereafter available for further processing and evaluation.

The sensor with its associated memory is connected to a computer, and the pixel data is transferred to the computer, under software control, which controls and performs the analysis of the image. Using software available from the manufacturer of the sensor, a plurality of inspections zones or inspection lines extending across and along the image of the edge of the disk, may be designated by an operator. Also, one or more rectangular inspection zones may be designated which overlie at least a portion of the image of the edge of the disk. Both transverse and longitudinal inspection lines along the image of an edge as well as an area enclosed within a rectangular inspection zone define effectively which line of pixels or area of pixels and, more specifically, which pixel values will be used in evaluating an inspected segment of the disk edge surface. In the case of the inspection zones defined by a single inspection line, the line correlates to a line or row of pixels of the digital image along which the stored illumination intensity values then are evaluated.

The illumination level of each pixel is electronically assigned a relative numerical value, brightness representation. This pixel brightness value is stored in correlation to the pixel location and may be used and considered in conjunction with adjacent or nearby pixel brightness values. A threshold value for a pixel to be designated an anomaly is established by the operator. Whenever a line or area inspection zone is established and queried, the number of contiguous or adjacent pixels which have illumination intensity values that exceed a previously established threshold value may be determined. Anytime the number of adjacent pixels along the inspection line or the number of such pixels within the area inspection zone are greater than a threshold value or exceeds a predetermined number, then the number of pixels with an illumination intensity greater than the previously established brightness threshold may be translated into or correlated with a dimension along a particular inspection line or correlated with an anomaly concentration within the inspected area because the pixels each represent a spot with at least a linear dimension. A large enough bright contiguous pixel count is considered to be a result of an anomaly or defect of sufficient size to warrant both rejection of a glass disk and its removal from further processing. The use of the exact size of the anomaly in conventional measurement units is not necessary as a threshold may be specified in terms of pixel counts.

If the designated inspection zones are lines, adjacent bright pixels on the designated line are counted; if the inspection zone is an area, the total count of bright pixels, specifically those bright pixels with illumination intensity values greater than the previously established threshold, are counted notwithstanding lack of contiguous positioning.

If any of the predetermined bright pixel count criteria for a rejection is exceeded, the glass disk substrate is rejected as unacceptable.

### BRIEF DESCRIPTION OF THE DRAWINGS

FIG. 1 is a schematic diagram representing the test set-up for implementing this invention.

FIG. 2 is a diagram showing a view of a computer monitor image representing a glass disk edge surface being inspected along with examples of various inspection zones designating pixels to be considered in detecting anomalies in an edge surface of the disk.

FIG. 3 is a partial section-view of the glass disk substrate being inspected taken along line 3-3 in FIG. 1.

### DETAILED DESCRIPTION OF THE PREFERRED EMBODIMENT OF THE BEST MODE FOR CARRYING OUT THE INVENTION AS CONTEMPLATED BY THE INVENTORS

The glass disk 12 and elements of the disk 12 together with images of the respective glass disk 12 are referred to by the same reference numerals for simplicity sake.

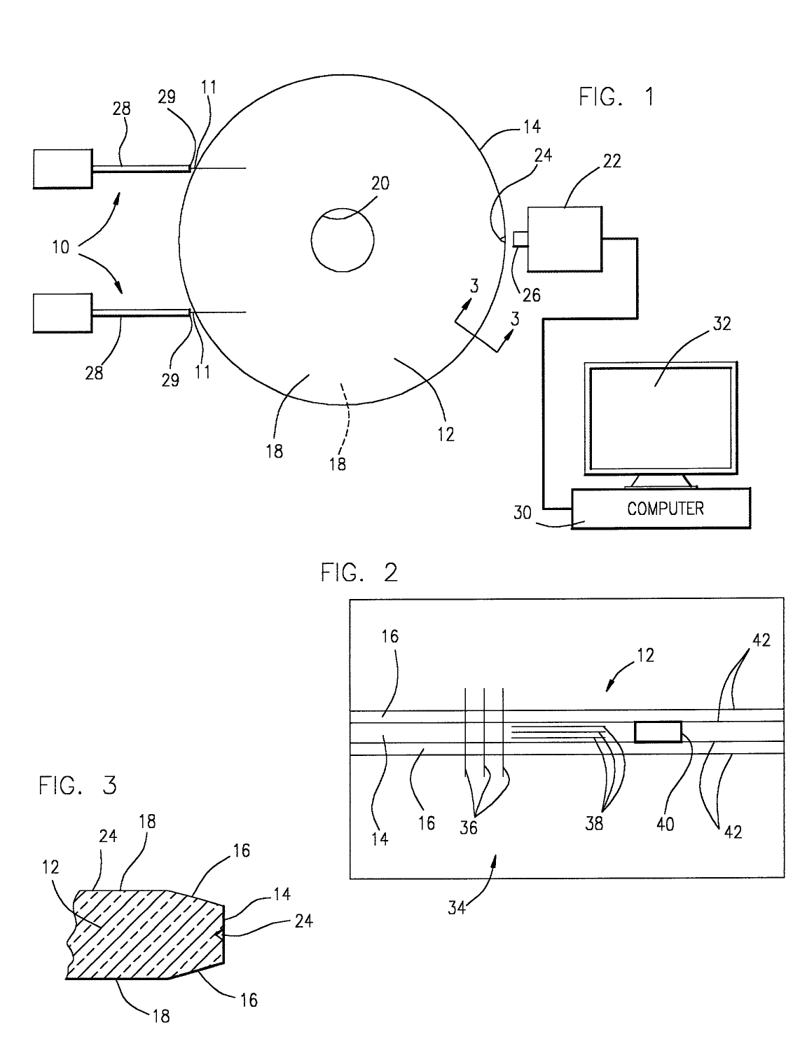

Refer initially to FIG. 1 as well as FIGS. 2 and 3 of the drawings. Glass substrates 12 form the core of magnetic hard disks on which data is stored in hard disk drives of computers and similar devices such as servers and routers as well as for use in DVD (digital video drive) drives, (not shown). Inspection of these substrates 12 is intended to detect internal defects in the glass disk substrate early in the manufacturing process in order to avoid any further investment in defective products.

The inspection process utilizes a beam 11 of high-intensity from a white light source 10 which is aimed at and impinged upon a peripheral edge surface 14 of a glass disk substrate 12. The light beam 11 is aimed obliquely at the substantially cylindrical peripheral surface 14 of the disk 12 and between chamfers 16 located at the edge of planar surfaces 18 of glass disk substrate 12.

FIG. 1 shows the orientation of the light sources 10 and the light beam 11 relative to a glass disk substrate 12. The light source 10 is disposed to be aimed on an axis that does not intersect the central opening 20 in the disk 12 while maintaining the axis of the light beam 11 at the point of impingement on an outer peripheral surface 14 parallel to the parallel planar surfaces 18 of the glass disk 12.

While an edge 14 of the disk 12 may reflect some of the light from light source 10 away into space, a sufficient portion of illumination of light beam 11 will enter the body of the glass disk 12. The parallel planar surfaces 18 of disk 12 will internally reflect and constrain most of the light entering an edge 14 of a glass disk 12, and the light internal to the disk 12 will continue through the transparent glass and reflect off other interior portions of edge surface 14 of the disk 12 until the light strikes an edge surface 14 of the disk 12 at an angle which permits the light to exit the disk 12 through edge surface 14 and pass harmlessly into the surrounding space.

Positioned closely juxtaposed to an edge surface 14 of disk 12 is a CCD camera 22 or sensor 22, which is a very high-speed digital camera. At least when operating in a monochrome mode, the camera 22 electronically records the relative light intensity for each pixel (picture element) of an image. The digital representation of that portion of the image representing pixels on edge 14 of the glass disk substrate 12 may be computed and analyzed to provide an illumination intensity level on a relative scale for each discrete site on cylindrical outer surface 14 of disk 12. The illumination intensity level for each such discrete site is represented by the respective pixel illumination intensity value stored in the memory of the computer 30 and the sensor 22.

Whenever an anomaly or defect 24, such as a chip or crack, is positioned within the field of view of the CCD sensor 22, the illumination level of the light escaping the glass disk substrate 12 at the location of that anomaly 24 will be significantly brighter and thus will indicate an anomaly 24 in edge surface 14 of the disk 12. Whenever the anomaly 24 or defect 24 is within the field of view of the CCD sensor 22, the anomaly 24 will appear as a bright spot to the CCD sensor 22 and will be recorded as a spot with a high illumination level or bright pixel or pixels, depending on size, by the sensor 22.

If disk 12 is inspected using a technique as described in co-pending U.S. patent application Ser. No. 09/489,342, referenced above, a crack or chip in edge 14 of the disk 12 may not be adequately detected due to illumination which does not extend all the way to outer edge 14 of glass disk 12; therefore, some edge defects may escape detection. Also, this detection technique relies on blockage of or reduction of a light beam to indicate a defect. A non-defective region will directly pass the inspection light beam. The passage of light directed substantially perpendicular to the planar surface 18 of a disk 12, through the disk directly, will not adequately detect very small surface imperfections on edge surface 14 of a disk 12. Thus, these two inspection approaches are complementary inasmuch as different defects in separate locations are addressed in different manners.

With edge illumination of disk 12, the edge surface defects 24 may be detected. A bright white light beam 11 does not exit the periphery of the disk 12 as a beam; the light beam 11 is reflected and distributed about internally within the glass disk 12, thus having a low illumination intensity as light beam 11 exits edge surface 14 and does not brightly radiate to the lens 26 of CCD sensor 22. The CCD camera 22 or CCD sensor 22 may be any of various suitable CCD sensors. For purposes of illustration and example, the CCD camera 22 or sensor 22, referred to herein, is a DVT SmartImage Sensor, Series 600, Model 630 available from DVT Corporation of Norcross, Ga. 33093.

The CCD camera 22 or CCD sensor 22 captures an image of an arc segment of disk edge surface 14 as a matrix of pixels and creates an illumination intensity value for each pixel. Each pixel is representative of the brightness of a small spot on cylindrical outer edge surface 14 of the glass disk 12. The brightness of the segment of outer edge surface 14 is derived from the light of the light sources 10. The light sources 10 each further comprise an optical fiber bundle 28. The radiating end 29 of the optical fiber bundle 28 is disposed juxtaposed with cylindrical edge surface 14 of glass disk 12.

As light delivered to disk edge 14 by the optical fiber bundle 28 is transmitted through the glass of disk 12, the light rays encounter various portions of cylindrical edge surface 14. Some light rays will escape while other portions of the light will be internally reflected. Light rays will continue to be reflected from the interior of edge surface 14 until the light rays encounter a portion of cylindrical outer surface 14 of the glass disk 12 at an angle which does not reflect the light ray internally, but instead permits the light to escape through the surface of the edge 14 of the disk 12.

Light rays striking the cylindrical surface forming edge 14 of disk 12 are reflected internally, the image of edge 14 of the glass disk 12 remains relatively dark as very little light escapes through any particular area of edge surface 14; consequently, the light does not significantly illuminate the lens 24 of CCD sensor 22. However, the presence of a crack or chip 24 in edge surface 14 of disk 12 will cause an interception of and diffusion of multiple, internally reflected light rays within disk 12. The result of this interception and diffusion of the light rays is a substantial brightening of the anomaly 24, making the anomaly 24 clearly and easily discernable against the darker surrounding area of the image of the edge 14, where the image includes an arc segment about 5 mm in length.

Refer at this point to FIG. 2. The CCD sensor 22 records a pixel matrix image of edge surface 14 of the glass disk 12 in approximately 5 mm segments. Other lengths of arc of the disk edge 14 may be used and imaged, if desired. The CCD sensor 22 provides in a conventional manner pixel the illumination intensity values to a computer 30, and the sensor image 34 may be displayed thereafter on a display 32. Individual pixels provide the data from which the visual image of the disk 12 edge 14 is rendered on the display 32.

The processing software provided with a DVT SmartImage sensor 22 permits the operator to define lines or areas for consideration in the inspection process. Typical zones of consideration may be vertical lines 36 spanning the thickness of the pixel image or horizontal lines 38 extending horizontally across the pixel image of the inspected arc segment. Also, a rectangular area 40 may be defined as an inspection zone. Zones of other configurations may be defined if desired, but horizontal 38 and vertical 36 lines and rectangular areas 40 are used as exemplary herein.

Along or on a predesignated single line 36, 38 or inspection zone 36, 38 of a particular image captured and stored in the computer memory, pixels may be considered in analyzing and testing for defects. The individual pixels are stored in the computer memory along with a numerical brightness or illumination intensity value. Thus, individual pixels may be evaluated by the computer 30, under software or program control, and a determination be reached as to whether there is a bright segment of one of the vertical inspection lines or zones 36 or horizontal inspections lines or zones 38 which is indicative of a feature. Segments of each line 36, 38 are referred to as features when a number of adjacent pixels form a segment, which is either dark or bright relative to an adjacent segment.

Computer 30 will count under software control the number of consecutive contiguous pixels in a feature along one of the predesignated inspections zone lines 36, 38 which are brighter than a predesignated threshold value of brightness are counted. A predesignated brightness threshold may be set by the operator at an empirically determined value which has been shown to represent the minimum value for an anomaly 24 that may be part of a defect. This value may be determined empirically by determining the brightness value of known defects and basing the threshold value considered unacceptable on those empirically determined values. After testing both previously unknown defects and the disks on which the previously unknown defects are resident at rotational speeds at least exceeding the normal or specified rotational operating speeds for the finished magnetic recording disk, then the designated threshold value may be adjusted as testing experience warrants.

As each pixel correlates to a corresponding spot on edge surfaces 14 of the test specimen 12, a single isolated bright pixel generally may be ignored as a very small surface anomaly 24, while several bright pixels adjacent one another may indicate a more significant defect. For example, a single pixel anomaly is so small that the centrifugal forces exerted on the glass material surrounding the single pixel represented point will not cause the disk 12 to fail through breakage. On the other hand, a defect 24 that is represented on the image as a plurality of contiguous bright pixels probably is large enough to adversely affect the structural integrity of the glass of the disk 12 at that point, as that glass structure of the disk 12 will be weakened and potentially may fail under operating speed conditions. As an example, anomalies 24 that have five or more contiguous pixels brighter than “a threshold value of brightness” will be designated as an anomaly to be considered a “rejectable defect,” because the defect will not only be along the considered inspection zone or line 36 but also undoubtedly will have a width in excess of one pixel in at least some of the anomaly's form.

The stage of manufacture at which glass disk substrates 12 are inspected for edge cracks and chips is prior to coating the disk 12 with the magnetic recordable material used to transform the glass disk into a magnetically recordable data storage disk. Therefore, the manufacturing cost investment made in a glass disk 12 up to the point of this discussed edge inspection is relatively minor compared to the cost of complete manufacture of the magnetic storage disk. Thus, relatively little is lost in to discard a glass disk substrate 12 in a relatively early stage in the manufacturing process sequence.

The software associated with the DVT SmartImage Sensor also provides for designating an area having both a length and width, such as a rectangle 40, to be designated as an inspection zone 40. For simplicity of illustration, while the various inspection zones 36, 38, 40 are shown as not overlapping, a practical approach would be to provide more vertical lines 36 distributing the designated inspection zones across the entire width of the image or inspections segment viewed by the sensor 22. Similarly, the horizontal inspection lines 38 would be extended to span substantially the entire width of the inspection segment of edge 14 of the disk 12 as displayed on the monitor 32 of computer 30. The rectangular inspection zone or zones 40 should encompass more than one-third and preferably at least one-half of the inspection segment of periphery 14 of disk 12.

If the predesignated number of bright pixels set for the area inspection zone 40 is exceeded notwithstanding the passage of inspection criteria for vertical and horizontal inspection lines 36, 38, the test specimen is failed and rejected.

The number of bright contiguous pixels designated as a rejection threshold for the vertical 36 and horizontal 38 inspection lines must be that, if exceeded,. which will represent a chip, crack or other feature 24 of sufficient size as to threaten the integrity of the disk 12 at normal operating speeds.

The inspection image capture takes place in the CCD sensor 22 while the test specimen 12 is being rotated at a speed sufficiently slow to be able to capture all of the segments of periphery 14 of the disk 12 in a small number of revolutions such as, for example, three revolutions. If assembled, the total image captures would overlap and insure that every point on disk edge surface 14 would be contained well within the limits of at least one image. Thus, if a defect 24 is not completely captured in a single frame on one pass, it will be fully captured on at least one of the other revolutions.

If a sufficient number of bright pixels is detected within the area inspection zone 40 although not necessarily contiguous, this may indicate sufficient weakness of the glass disk 12 that it cannot withstand the stresses of normal operational speed with a reasonable margin of safety, and thus should be discarded as defective.

If a fail or reject criteria is met in regard to any one of the numerous inspections zones 36, 38, 40 and various forms designated, the specimen substrate disk 12 is failed and the disk 12 discarded.

The preferred locations of the light sources 10, specifically, the radiating ends of the optical fiber bundles 28, are positioned in the vicinity of eight o'clock and ten o'clock positions while the CCD digital optical sensor 22 is located in the vicinity of the three o'clock position as illustrated in FIG. 1. Further, the light sources 10 are aimed at edge 14 of the disk 12 and the direction of the light rays 11 are disposed substantially parallel to each other as illustrated. This placement of the light sources 10 and light rays 11 insure the illumination of any edge anomaly 24 from both sides whenever anomaly 24 is disposed adjacent the sensor 22 and particularly the sensor lens 26.

The light sources 10 for illuminating the disk 12 may be lasers if the results are warranted; however, white light beam 11 is preferred. A change from white light 11 may be warranted based on the characteristics of the particular glass used in forming the disk substrate 12.

A typical rotational speed during inspection is 10 RPM but some other speed may be selected based on the rapidity with which the CCD sensor 22 can record consecutive images, the width of a satisfactorily focused arc segment image, and the processing speed of the computer 30.

The internal illumination of the disk 12 serves to illuminate the chamfer 16 and the cylindrical surface 14 of the disk 12 in FIG. 3; and the junctions of these surfaces is a sufficient discontinuity to provide bright lines 42 of pixels defining the two edges of cylindrical peripheral surface 14 or edge 14 of disk 12 and displayed in FIG. 2. The bright line 42 advantageously may be used by the system operator to guide the operator in the selection of the specific portions of the image to span with the designated inspection zones 36, 38, 40.

While the various threshold values may vary from test set-up to test set-up, the concepts described are consistent and applicable to this test technique, and the described values are exemplary and provided by way of example.

With the understanding provided by the foregoing Detailed Description of the Invention, those of skill in the art will be enabled to make minor modifications in the process, but such minor modifications will not remove the resulting process from the scope of the invention as defined by the appended claims.

The foregoing Detailed Description of the Invention is to provide one of ordinary skill in the art the knowledge to practice the invention and is not intended nor should it be used to limit the scope of the invention defined in the attached claims.

We claim:

1. A method of inspecting glass disk substrate edges for cracks and chips, comprising the steps of:
mounting said glass disk substrate for rotation;
rotating said glass disk substrate at a predetermined rotational velocity;
illuminating an edge of said disk with at least one high-intensity light source;
detecting a light brightness level of said edge at a detection station;
detecting changes in said light brightness level in at least one predesignated inspection zone of a region of inspection;
establishing an illumination brightness level corresponding to a defect in said edge of said disk;
correlating said changes in said light brightness level with said illumination brightness level;
determining a number of adjacent pixels exceeding said established illumination brightness level in each of said at least one predesignated inspection zone;
comparing said number of adjacent pixels to a predetermined number, and
whereby anomalies in said edge of said disk are detected and linearly measured in at least one dimension and said disk is rejected based on the size of said anomaly in said predesignated inspection zone.

2. The method of detecting defects in an edge of a glass disk substrate comprising the steps of:
brightly illuminating said edge of said glass disk;
determining an illumination level threshold representing a predetermined anomaly in said edge of said glass disk;
determining a number of discrete locations within an inspection zone which shall constitute an anomaly sufficient to warrant rejection of said glass disk;
detecting a level of illumination radiating from said edge of said glass disk; measuring said level of illumination radiating from said edge of said disk at discrete locations in an image of said edge of said glass disk;
storing said measured level of illumination as a digital value for each of said discrete locations;
designating an inspection zone within said image of said edge of said glass disk;
determining a number of said compared digital values which equal or exceed said illumination level threshold within said inspection zone, which constitute a basis for rejecting said glass disk;
selecting a plurality of said stored digital values associated with said designated inspection zone;
comparing said stored digital values associated with said designated inspection zone with said previously determined radiating illumination threshold and determining the number of said compared digital values which equal or exceed said illumination level threshold, and
determining as unacceptable any glass disk substrate having a number of said compared digital values which equal or exceed said illumination level threshold that equals or exceeds said determined number.

3. The method of detecting defects in an edge of a glass disk substrate of claim 2 wherein said disk is rotated relative to said illumination.

4. The method of detecting defects in an edge of a glass disk substrate of claim 3 wherein said detecting step is accomplished with a CCD sensor.

5. The method of detecting defects in an edge of a glass disk substrate of claim 4 wherein said illuminating step passes light to said sensor indirectly.

6. The method of detecting defects in an edge of a glass disk substrate of claim 5 wherein said illuminating impinges a beam of light onto said edge parallel to a plane of said disk.

7. A method of inspecting edges of a glass disk substrate comprising the steps of:
defining a threshold illumination intensity constituting an anomaly in said edge of said rotating glass disk;
illuminating said disk through an edge of said disk;
detecting refracted light passing outwardly through said edge;
recording a digital image of said refracted light;
quantifying a level of illumination intensity for each pixel of said digital image;
establishing at least one inspection zone relative to said digital image;.
defining an inspection criteria of fault counts for said at least one inspection zone;
assigning a fault count to each pixel associated with said at least one inspection zone with a quantified level of illumination intensity greater than said defined threshold illumination intensity;
comparing said fault count with said inspection criteria of fault counts for each said at least one inspection zone, and
determining if said fault count exceeds said inspection criteria of fault counts.

8. The method of claim 7 comprising the additional step of designating any said glass disk having a determination of said fault count exceeding said inspection criteria fault count as rejected.

9. The method of claim 8 wherein said illumination step is accomplished by directing said illumination through an optical fiber aligned with a plane of said disk.

10. The method of claim 9 comprising the additional step of positioning said optical fiber relative to said disk so that illumination from said optical fiber cannot pass directly to a position on said edge of said disk wherein said step of detecting said refracted light occurs.

11. The method of claim 10 wherein said detecting step is accomplished by recording said image as a plurality of pixels in a CCD sensor.

12. The method of claim 11 wherein illumination intensity representations of each of said recorded pixels of images of segments of said glass disk edge are delivered to a computer.
